(19) United States
(12) Patent Application Publication
(10) Pub. No.: US 2010/0035638 A1
(43) Pub. Date: Feb. 11, 2010

(54) SYSTEM AND METHOD OF MOBILE PHONES FOR SENDING PREDETERMINED MESSAGE TO ASSOCIATED PHONES

(75) Inventors: YI-FANG WU, Tu-Cheng (TW); YUAN HUANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD ., Shenzhen City (CN); HON HAI PRECISION INDUSTRY CO., LTD., Tu-Cheng (TW)

(21) Appl. No.: 12/264,427

(22) Filed: Nov. 4, 2008

(30) Foreign Application Priority Data
Aug. 8, 2008 (CN) 200810303599.0

(51) Int. Cl. H04W 4/12

(52) U.S. Cl. 455/466

(57) ABSTRACT

A system and method of mobile phone for automatically sending message to a target phone is provided. The includes a touch sensing unit configured to detect an external touch input applied to the touch sensing unit and transform the touch input into a digital signal, a microprocessor configured to receive the input digital signal and compare the input digital signal with digital reference signals stored in the microprocessor, and a message sending unit controlled by the microprocessor according to a comparison result to send message to a a predetermined target phone associated with the message.

### BACKGROUND

1. Technical Field

The present disclosure relates to systems and methods of mobile phones for sending predetermined messages to associated target phones.

2. General Background

Text message service is now prevalent for mobile phones. Text messages typically consist of combinations of characters and numerals. The text messages are generally written and transmitted to a target phone by users through the use of a keypad on the mobile phone or a virtual keypad on a display of the mobile phone. Some mobile phones store messages. Users can select a predetermined or previously written message stored in the phone, and then send the message to a destination phone number. However, the user must select the destination phone number from an address list stored in the mobile phone or enter the phone number via the keypad. If some messages are regularly sent to particular destination phone numbers, then the above actions are repetitive.

What is needed, therefore, is a system and method of a mobile phone for sending predetermined messages to associated phone numbers.

### BRIEF DESCRIPTION OF THE DRAWINGS

FIG. 1 is a block diagram of one embodiment of a mobile phone system for sending predetermined messages to predetermined target phones associated with the messages.

FIG. 2 is a flow chart of one embodiment of a method for sending predetermined messages to predetermined target phones associated with the messages.

FIG. 3 is a block diagram illustrating corresponding relationships among input symbols, message content, and target phone numbers associated with the message content.

### DETAILED DESCRIPTION OF THE EMBODIMENTS

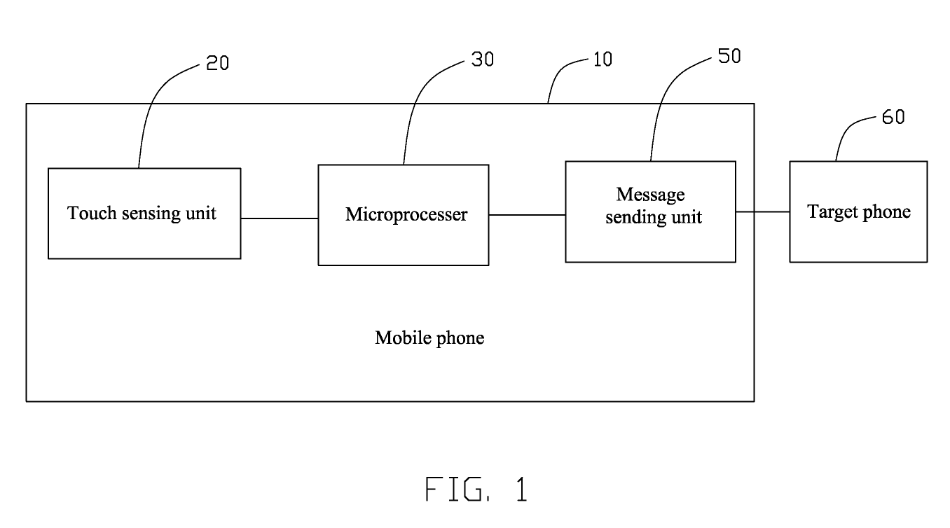

Referring to FIG. 1, one embodiment of a system arranged in a mobile phone 10 for automatically sending messages to a predetermined target phone 60 is provided, which includes a touch sensing unit 20, a microprocessor 30, and a message sending unit 50 controlled by the microprocessor 30.

The touch sensing unit 20 and the message sending unit 50 are electrically connected to the microprocessor 30. A plurality of digital reference signals, different messages corresponding to the reference signals, and target phone numbers associated with the messages are stored in the microprocessor 30. In one embodiment, users can apply a sliding touch, taps, or combinations of the two in a particular pattern associated with one of the desired messages and one of the target phone numbers on the touch sensing unit 20 of the mobile phone 10. In another embodiment, the touch sensing unit 20 is a touch screen displaying a plurality of icons in which users can touch an icon associated with a desired message and a target phone number. The touch sensing unit 20 identifies touch input and transforms the touch input into corresponding digital signals and outputs the digital signals to the microprocessor 30.

When a digital signal from the touch sensing unit 20 is inputted to the microprocessor 30, the microprocessor 30 compares the input digital signal with the digital reference signals stored therein. If the input digital signal matches one of the reference signals, the microprocessor 30 instructs the message sending unit 50 to send a corresponding message to the target phone 60 associated with the reference signal.

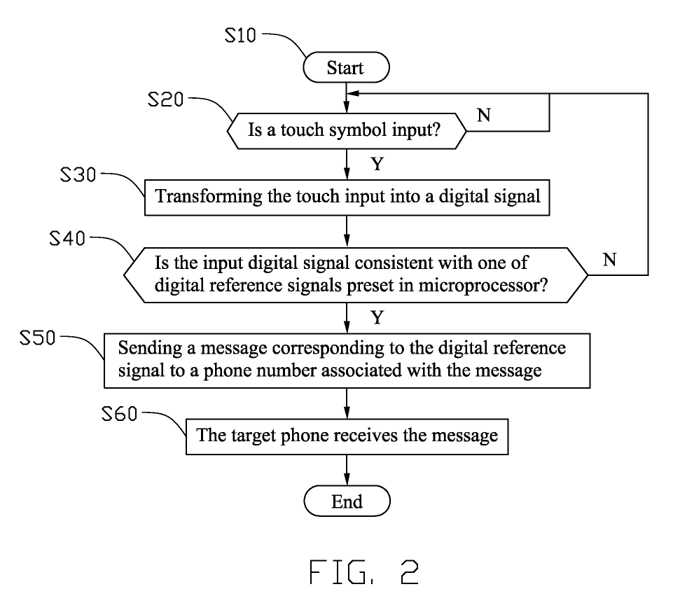

FIG. 2 is a flowchart illustrating one embodiment of a method for automatically sending a message to a target phone. Depending on the embodiment, certain of the steps described below may be removed, others may be added, and the sequence of steps may be altered.

In step S10, the mobile phone is turned on.

In step S20, the touch sensing unit 20 detects if a touch input has been applied to the touch sensing unit 20 of the mobile phone 10. If a touch input has been detected, the method continues to step S30. Otherwise, the method repeats step S20.

In step S30, the touch input is transformed into a corresponding digital signal and sent to the microprocessor 30.

In step S40, the microprocessor 30 checks if the corresponding digital signal matches one of the preset digital reference signals. If the corresponding digital signal matches one of the preset digital reference signal, the method continues to step S50. Otherwise, the method returns to step S20.

In step S50, the microprocessor 30 sends a command to instruct the message sending unit 50 to send a message corresponding to the reference signal to a phone number associated with the message.

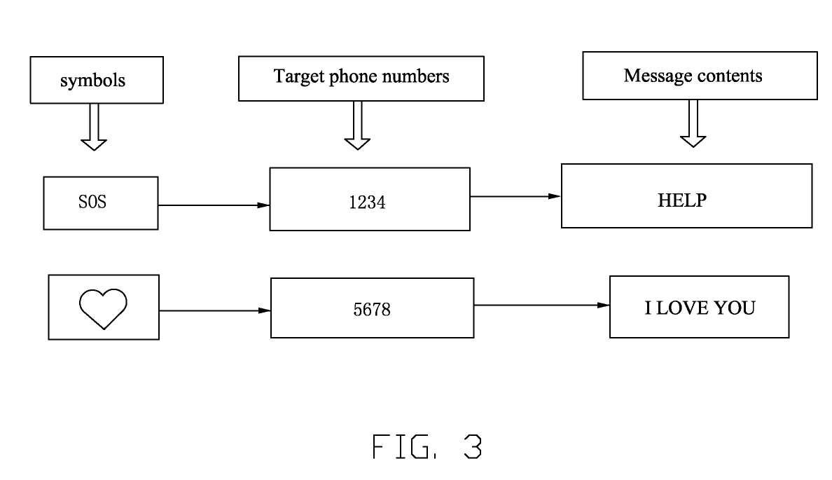

FIG. 3 illustrates specific touch patterns that may be set to correspond to pre-written messages and associated target phone numbers. For example, if a user uses three sliding touches to form a three-letter pattern “SOS,” a message with the content “HELP” would be sent to an associated phone number 1234. In another example, if the user traces a heart shape on the touch sensing unit, a message “I LOVE YOU” would be sent to an associated phone number 5678.

It is to be understood, however, that even though numerous characteristics and advantages of the embodiments have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile phone system, comprising:
a touch sensing unit configured to detect an external touch input applied to the touch sensing unit and transform the touch input into an input digital signal;
a microprocessor configured to receive the input digital signal, compare the input digital signal with reference digital signals stored in the microprocessor, and send a command if the input digital signal matches one of the reference digital signals; and
a message sending unit being configured to receive the command from the microprocessor to send a message associated with the reference digital signal to a predetermined target phone associated with the message.

2. The mobile phone system of claim 1, wherein the touch sensing unit is capable of detecting touches and taps in particular patterns; a plurality of message contents corresponding to the particular patterns are stored in the microprocessor; a plurality of target phone numbers is associated with the message contents.

3. The mobile phone system of claim 2, wherein the message sending unit sends a corresponding one of the message contents to a corresponding one of the target phone number associated with the corresponding one of the message contents if the input digital signal outputted from the touch sensing unit is consistent with one of the reference digital signals,

4. A method for automatically sending messages from a user mobile phone to target phones, the method comprising
detecting if a touch input is applied to a touch sensing unit of the user mobile phone;
transforming the touch input into a corresponding digital signal and sending the corresponding digital signal to a microprocessor;
comparing the corresponding digital signal with digital reference signals stored in the microprocessor; and
sending a corresponding message to at least one of the target phones associated with the corresponding message by a message sending unit if the corresponding digital signal is consistent with one of the digital reference signals.

5. The method of claim 4, wherein the touch sensing unit is capable of detecting touches and taps in particular patterns; a plurality of message contents corresponding to the particular patterns are stored in the microprocessor; a plurality of target phone numbers is associated with the message contents.

6. The method of claim 5, wherein the microprocessor sends a command to the message sending unit instructing the message sending unit to send the corresponding message to the at least one of the target phones associated with the corresponding message.

7. The method of mobile phone of claim 5, wherein one of the corresponding message content is “HELP” if one of the particular patterns is “SOS.”

8. The method of mobile phone of claim 5, wherein one of the corresponding message contents is “I LOVE YOU” if one of the particular patterns is heart-shaped.
